(19) United States
(12) Patent Application Publication
(10) Pub. No.: US 2011/0290474 A1
(43) Pub. Date: Dec. 1, 2011

(54) CENTRALISING TOOL AND METHOD OF FORMING

(76) Inventor: Brian Nutley, Aberdeenshire (GB)

(21) Appl. No.: 13/130,396

(22) PCT Filed: Nov. 23, 2009
(86) PCT No.: PCT/GB2009/051588

§ 371 Date: Aug. 17, 2011

(30) Foreign Application Priority Data
Nov. 21, 2008 (GB) 0821314.2

(51) Int. Cl. E21B 17/10; B23K 9/00; B23K 31/02; B23K 9/16

(52) U.S. Cl. 166/241.1; 219/75; 219/137 R; 228/101; 228/160; 228/155; 228/176

(57) ABSTRACT

The invention relates to a centralizing tool, and to a method of forming a centralizing tool. A disclosed method of assembling a wellbore centralizer includes the step of providing a plurality of centralizing members, each centralizing member being of unitary construction and having a first circumferential part, a second circumferential part, and a longitudinal part disposed between the first and second circumferential parts. A first collar is formed by welding the first circumferential parts into a ring. A second collar is formed by welding the second circumferential parts into a ring.

The present invention relates to centralising tools for the hydrocarbon exploration and production industry and to methods of forming such tools.

It is well known to use centralising tools to properly place downhole tubulars in a wellbore during run-in and/or cementation. The centraliser comprises upstanding formations which provide stand-off to the tubular, and flow areas between the formations allow the passage of fluid past the centraliser. Centralisers are typically run downhole on casing strings to place the casing co-axially with an existing bore or tubing. The outer wall of the casing string being run is maintained at a distance from the surrounding wall, which allows cement to flow uniformly around the centraliser in the annular space. This increases the prospects of a good cement job which properly isolates the wellbore from the casing, preventing hydrocarbons from escaping to the surface along the annulus between the tubing sections.

Centralisers are also run between strings of production tubing and casing and production tubulars and open holes in production wells, to centralise the pipes co-axially with an existing bore or tubing. This enables the centralised deployment of completion and perforating tools and uniform deployment of viscous and non-viscous aqueous and hydrocarbon fluids which can carry particles or chemicals in the annular space for sand, water and scale management operations.

Centralisers are also run to provide protection to a tubular. A centraliser may be run in a deviating or lateral well, and may reduce frictional drag and associated damage to the tubular.

A bow spring centraliser is one type of centraliser which is used on casing strings. An example of a bow spring centraliser is illustrated in GB 664905. The centraliser comprises a body and a number of arched metal strips distributed circumferentially on the body. Radial forces experienced by the metal strips are directed into the body of the centraliser. A typical bow spring centraliser has a degree of resilience in the radial direction, and the body may be designed extend axially to a small extent due to the force from the spring.

Bow spring centralisers are typically considered to be of low to moderate strength, and therefore are not suitable for some centralising applications. Weaknesses in the centraliser arise from joins or seams in the components of the centraliser. Typically, the arched spring metal strips will be fixed to a centraliser body, which limits the extent to which axial and radial forces can be withstood. Radial forces due to side loads on the casing string being run are imparted on the centraliser and cause the bow to flex, with the forces directed into the centraliser body via the join. Bow spring centralisers must therefore be formed of materials which are sufficiently resilient to flex to overcome obstacles without a detaching at the joins or seams. This places limitations on the materials which can be used. In addition, a balance must be reached between resilience deformability and rigidity: a more pliable or deformable centraliser spring has a reduced ability to centralise heavy casing sections in inclined or lateral wellbores and provide the necessary standoff for the required concentric separation.

Improvements have been made to bow spring centraliser design, and in U.S. Pat. No. 3,312,285 there is described a bow spring centraliser without joins between the arches and the body. The centraliser body and arches are formed from a single sheet of metal, which is cut into the required form. The collars of the body and the arches are defined by cutting windows in the steel material. The steel is then deformed using a hydraulic ram to press form the bends into the arch section. The sheet steel is formed around a mandrel to create a cylindrical body. Opposing edges of the sheet are welded to form an axial seam.

This centraliser design has the advantage that there are no welds between the arch sections and the collar sections, which increases the axial and radial forces that the centraliser is capable of withstanding. However, the manufacturing process may in some cases be difficult, time consuming and expensive. For example, forming a cylindrical body around the mandrel may introduce stresses to the steel sheet, which may damage the material and compromise the structural integrity of the body. In practice, this may be addressed by a sequential pressing of adjacent parts of the sheet in order to form the cylindrical body, which is a time consuming process. A similar device and method is described in EP 1399642, which requires the centraliser body to be formed from a sheet of boron steel to improve the manufacturing process. The document describes one method of forming the centraliser from two components which are connected by hinges.

WO99/64714 A1 describes an alternative centraliser formed from spring members mechanically attached to a separate collar.

In summary, disadvantages of existing centraliser designs include complexities in their respective manufacturing processes, restrictions on material, and/or limitations in their applications.

It is one aim of the invention to provide a centralising tool which overcomes or mitigates the drawbacks associated with prior art centralising tools. It is an aim of an aspect of the invention to provide a method of forming a centralising tool which is improved with respect to the prior art manufacturing processes. It is a further aspect of the invention to provide a kit of parts, which when assembled forms a centralising tool.

According to a first aspect of the invention, there is provided a method of assembling a wellbore centraliser, the method comprising:
providing a plurality of centralising members, each centralising member being of unitary construction and comprising a first circumferential part, a second circumferential part, and a longitudinal part disposed between the first and second circumferential parts;
forming a first collar by welding the first circumferential parts into a ring; and
forming a second collar by welding the second circumferential parts into a ring.

By forming a ring from circumferential parts of separate centralising members welded together, the invention provides certain advantages. Each circumferential part can be formed in a way that avoids undue stresses being introduced into the material. Each circumferential part may be formed in a carefully controlled press forming process, which improves circularity in the ring and collar, improving engineering tolerances. Certain welding processes, including but not limited to static fusion welding, allow pressure to be added to the circumferential parts forming the ring during welding, which improves the circularity of the ring. Improved circularity also facilitates the attachment of additional components to the centraliser, for example seals and/or turbulators.

The present invention also facilitates the use of different materials and/or dimensions of the centralising members. For example, each circumferential part may be more readily formed from a thinner sheet of material compared with the centralisers of the prior art.

The method may comprise the step of cutting or otherwise machining a centralising member from a sheet of material. The material may be a steel alloy. The material may be a carbon steel or a boron steel. Other materials may be used within the scope of the invention.

The first and second circumferential parts of the centraliser members may be shaped so as to form the first and second collars when the respective circumferential parts are welded together. Accordingly, the step of forming the first collar may comprise forming a first collar comprised entirely of the first circumferential parts; and the step of forming the second collar may comprise forming a second collar entirely of the second circumferential parts. The first and second collars can therefore be formed by welding the respective first and second circumferential parts of the circumferential members together. This may offer advantages in comparison to prior centralisers, particularly that disclosed in WO99/67414, in that the method may negate the requirement to provide separate collars. This may lead to manufacturing efficiencies in terms of reductions in manufacturing time, and may also offer significant strength benefits. In particular, the centraliser disclosed in WO99/67414 may suffer from a tendency, in use, for the spring bows welded to the end collars to deform the collars and, in extreme circumstances, tear out of the collars.

The first and second circumferential parts may be shaped so that each forms part of the respective first and second collars and such that, when welded together, the circumferential parts describe/define the collars. The first and second circumferential parts may be directly welded together to form the respective first and second collars. The first and second circumferential parts may be welded together to form first and second rings describing/defining the entire collars.

The method may comprise locating the first circumferential part of one centraliser member in abutment with the first circumferential part of another centraliser member, which parts are to be welded together, and which may form the first collar. The method may comprise locating the second circumferential part of one centraliser member in abutment with the second circumferential part of another centraliser member, which parts are to be welded together, and which may form the second collar. Where the centraliser comprises two centraliser members, the method may comprise locating a first (circumferential) end of the first circumferential part of the first member in abutment with a first end of the first circumferential part of the second member; and locating a second (circumferential) end of the first circumferential part of the first member in abutment with a second end of the first circumferential part of the second member. In a similar fashion, the method may comprise locating a first (circumferential) end of the second circumferential part of the first member in abutment with a first end of the second circumferential part of the second member; and locating a second (circumferential) end of the second circumferential part of the first member in abutment with a second end of the second circumferential part of the second member.

Where there are more than two centraliser members, the method may comprise locating a first (circumferential) end of the first circumferential part of a first member in abutment with a first end of the first circumferential part of a second member; and locating a second (circumferential) end of the first circumferential part of the first member in abutment with a an end of a first circumferential part of a further member. In a similar fashion, the method may comprise locating a first (circumferential) end of the second circumferential part of a first member in abutment with a first end of the second circumferential part of a second member; and locating a second (circumferential) end of the second circumferential part of the first member in abutment with an end of the second circumferential part of a further member.

Where there are more than two centraliser members, the first circumferential part of one centraliser member may be located in abutment with the circumferential parts of at least two further centraliser members. Also, the second circumferential part of one centraliser member may be located in abutment with the second circumferential parts of at least two further centraliser members.

The method may comprise providing at least one intermediate circumferential part, separate from the centraliser members, and which may be located between, optionally abutting, first or second circumferential parts of a pair of centraliser members. The intermediate part may be welded into and may form a part of the first or second collar. Each collar may comprise at least one intermediate circumferential part. The first circumferential parts and said intermediate part may form the entire first collar. The second circumferential parts and said intermediate part may form the entire second collar.

The method may comprise welding the first and/or second circumferential parts by a welding process, which may be selected from: fusion welding (which may be static fusion welding), MIG welding, TIG welding, and ARC welding. Fusion welding techniques used in embodiments of the present invention may for example be those as described in GB 448401, GB 540519 or U.S. Pat. no. 6,209,777. Other suitable welding techniques will be apparent to one skilled in the art of welding of components for centralisers.

In a preferred embodiment, the method comprises welding the first and/or second circumferential parts by a static fusion welding process. By static fusion welding, it may be meant a fusion welding process which is not dependent on relative movement (for example by rotation) in order to generate heat required to form the weld. GB 448401, GB 540519 or U.S. Pat. No. 6,209,777 contain descriptions of some examples of suitable static fusion welding parameters.

Where the steps of forming the first and/or second collars of the centraliser by welding comprise welding by a static fusion welding process, welding of the circumferential part of one centraliser member to a circumferential part of another centraliser member may comprise vibrating one or both of the centraliser members. Where there are more than two centraliser members, the static fusion welding process may comprise vibrating one, two or more of the centraliser members, and may optionally involve vibrating all of the centraliser members. The centraliser members may be vibrated sequentially or simultaneously. References herein to vibrating a centraliser member may be to the causing of a vibration of or in the centraliser member, and/or to the generation of a vibrational movement of or in the centraliser member. The vibration may be applied to part of a centraliser member, and may in particular be applied to the circumferential part of the centraliser member. The vibration load applied to a centraliser member may be controlled to produce vibrations of a desired frequency, and/or desired deflections of part or parts of the centraliser member(s), to produce a weld having desired characteristics. The vibrations may be generated electromagnetically, and the method may comprise securing a vibrator element to, or relative to, the centraliser member to be welded. A pair or pairs of electromagnets may be located relative to the vibrator element so as to vibrate the element back and forth when current is sequentially applied to the electromagnets. The amplitude of the vibrations may be controlled by variations in the current applied to the electromagnets. The frequency of the vibrations may be controlled by varying the frequency of the switching of current between the electromagnets. It will be appreciated that other methods of generating vibrations may be employed.

Where the steps of forming the first and/or second collars of the centraliser by welding comprise welding by a static fusion welding process, the welding of the circumferential part of one centraliser member to a circumferential part of another centraliser member may comprise imparting a force or load on, or applying pressure to, a centraliser member which is to be welded to another centraliser member. The method may involve imparting a force or load on both of the centraliser members. Where there are more than two centraliser members, the static fusion welding process may involve imparting a force on all of the centraliser members. The force may be imparted to the centraliser members sequentially or simultaneously. The method may comprise bringing opposed faces of the centraliser members which are to be welded together into abutment, and then imparting a force on at least one of the centraliser members to urge the faces towards one another. The contact pressure force between the faces may be controlled in order to produce a weld having desired characteristics, and this may be achieved by controlling the force imparted on the or each centraliser member.

The characteristics of a weld formed in a static fusion welding process may vary according to factors including: the amplitude of the vibrations; the frequency of the vibrations; and the contact pressure force between the faces to be welded together. For example, it may be possible to form welds having similar strength characteristics by, in one method, imparting higher frequency, lower amplitude vibrations than in a further method. Variations can also be achieved by varying the contact pressure force. In general terms, a relationship between the amplitude and/or frequency of vibrations and applied pressure may be such that pressure can be reduced if amplitude or frequency is increased.

The method may comprise the step of pressing and/or press forming the centralising member to bend the first and second circumferential parts. The method may further comprise pressing the centralising member against a female mould, the female mould having a curved surface.

The method may comprise the additional step of press forming the longitudinal part to create a stand-off portion or a spring portion. One or more of the press forming steps may be performed on materials which have not been heat-treated as part of the specific manufacturing process of the centralising member.

The method may include the step of fitting the plurality of centralising members together to define a ring or a partial ring. In a preferred embodiment, all of the plurality of centralising members are fitted together in an arrangement which defines a ring, prior to a welding step. In an alternative embodiment, two of the centralising members are fitted together to form a partial ring prior to a welding step, with subsequent centralising members fitted together prior to subsequent welding steps.

Preferably, the method includes the step of heat treating and/or tempering the centraliser. The purpose of the heat treating step is to adjust the hardness of the material used to form the centraliser. Suitable heat treating techniques and parameters are known in the art.

Centralising tools produced in accordance with the present invention and its embodiments lend themselves well to the provision of additional components on the centraliser. The method may therefore include the step of providing additional functional component(s) on the centraliser. The method may include the step of providing a seal and/or a turbulator or formation for creating turbulence in fluid passing the centraliser in use on the centraliser. One or more of such functional components may be disposed on one or both of the first and second collars.

According to a second aspect of the invention, there is provided a wellbore centraliser comprising: a plurality of centralising members, each centralising member being of unitary construction and comprising a first circumferential part; a second circumferential part; and a longitudinal part disposed between the first and second circumferential parts; wherein the centraliser comprises a first collar formed from a welded ring of the first circumferential parts of the plurality of centralising members, a second collar formed from a welded ring of the second circumferential parts of the plurality of centralising members, and wherein the longitudinal parts of the centralising members extend between the first and second collars longitudinally of the centraliser.

The wellbore centraliser may be a spring centraliser and the longitudinal part may define a spring portion.

Each unitary centralising member therefore defines a part of each collar and a longitudinal part of the centraliser. The circumferential parts may be welded into the ring together at opposing longitudinally edges, such that the welds extend longitudinally of the centralising members.

The first and/or second circumferential parts may be assembled to define a complete ring. Thus a collar may be formed entirely from the circumferential parts (which are continuous with the longitudinal part), without dependence on an auxiliary ring to support the longitudinal parts.

Preferably, the circumferential parts of the centralising members are welded to one another. Alternatively, the centraliser may comprise one or more intermediate circumferential parts.

The first and second circumferential parts of the centraliser members may be shaped so as to form the first and second welded collars. The first and second circumferential parts may be shaped such that each forms a part of the respective first and second collars so that, when welded together, the circumferential parts describe/define the entire collars.

The first circumferential part of one centraliser member may abut the first circumferential part of at least one further centraliser member, which members may together form the first welded collar. The second circumferential part of one centraliser member may abut the second circumferential part of at least one further centraliser member, which members may together form the second welded collar.

The first circumferential parts may define the longitudinal extent of the first collar and the second circumferential parts may define the longitudinal extent of the second collar.

The longitudinal edges may comprise interlocking profiles. Thus one edge of a circumferential part may interlock with an adjacent edge of an adjacent circumferential part. The respective edges may interlock to axially key the respective circumferential parts. The profiles may comprise at least one circumferentially extending tooth, and may comprise at least one circumferentially extending recess.

The circumferential parts may be part-cylindrical. The longitudinal members may also be part-cylindrical.

The centraliser may comprise two or more centralising members. Preferably, the centraliser comprises four to eight centralising members, and most preferably five or six.

According to a third aspect of the invention, there is provided a kit of parts, which when assembled together, form a wellbore centraliser, the kit of parts comprising: a plurality of centralising members, each centralising member being of unitary construction and comprising a first circumferential part, a second circumferential part, and a longitudinal part disposed between the first and second circumferential parts; wherein the first circumferential parts are configured to be welded into a ring to form a first collar of the centraliser, and the second circumferential parts are configured to be welded into a ring to form a second collar of the centraliser.

Embodiments of the third aspect of the invention may comprise features of the first or second aspects of the invention and their embodiments.

According to a fourth aspect of the invention, there is provided a method of forming a wellbore centraliser, the method comprising: fusion welding a plurality of centralising members together to form the wellbore centraliser. The method may comprise static fusion welding the centralising members together. Each centralising member may be of unitary construction, and may comprise a first circumferential part, a second circumferential part, and a longitudinal part disposed between the first and second circumferential parts.

According to a fifth aspect of the invention, there is provided a method of forming a bow spring centraliser, the method comprising: fusion welding a plurality of centralising members together to form the bow spring centraliser. The method may comprise static fusion welding the centralising members together. Each centralising member may be of unitary construction, and may comprise a first circumferential part, a second circumferential part, and a longitudinal part disposed between the first and second circumferential parts.

Embodiments of the fourth or fifth aspects of the invention may comprise features of the first aspect of the invention and its embodiments.

To improve an understanding of the invention, various example embodiments will be described with reference to the following drawings:

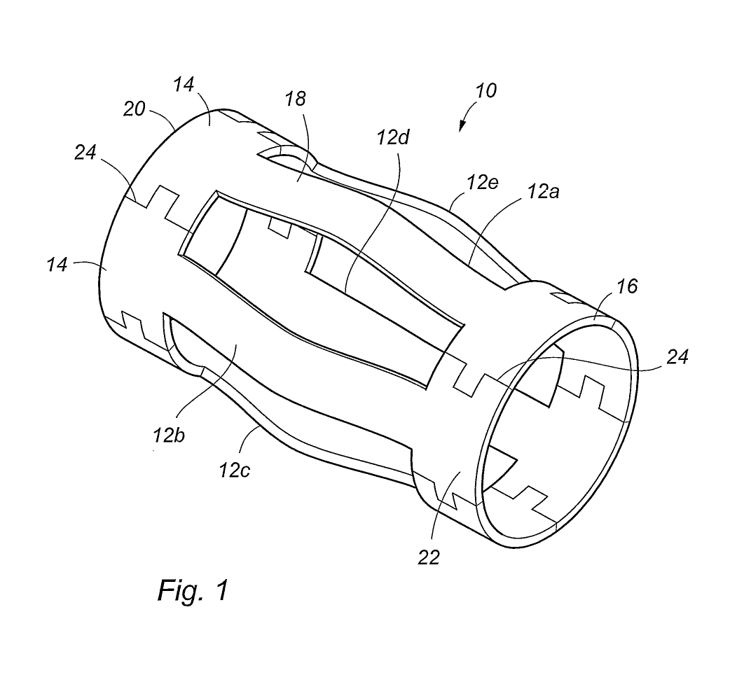

FIG. 1 is a perspective view of a centralising tool formed in accordance with a first embodiment of the invention;

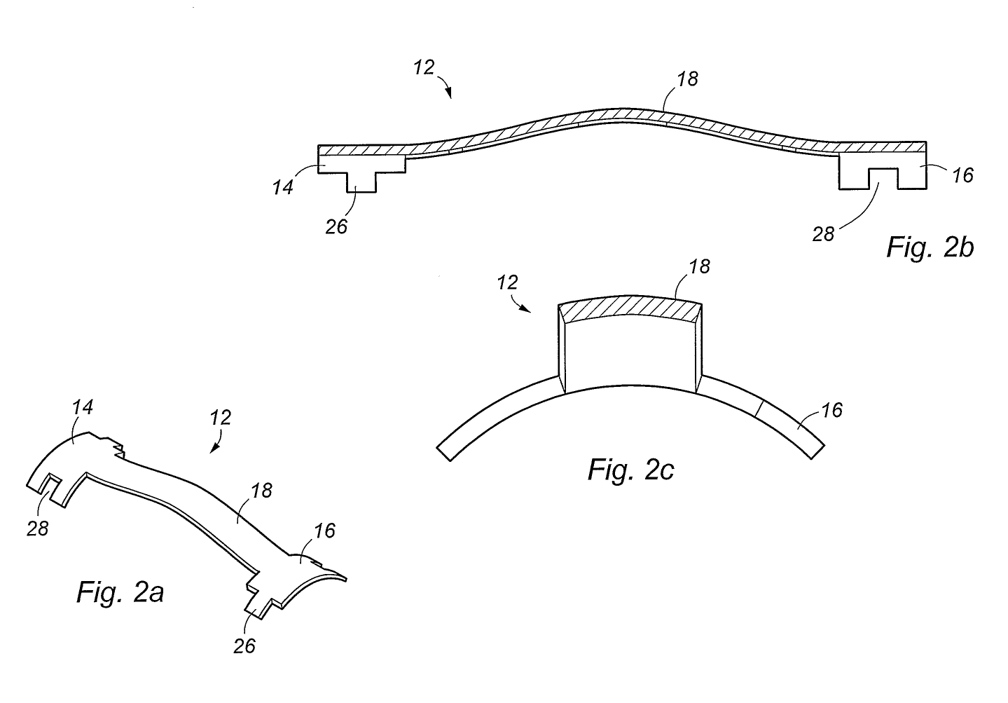

FIGS. 2A to 2C are respectively perspective, longitudinal section and transverse section views of a centralising member in accordance with the embodiment of FIG. 1;

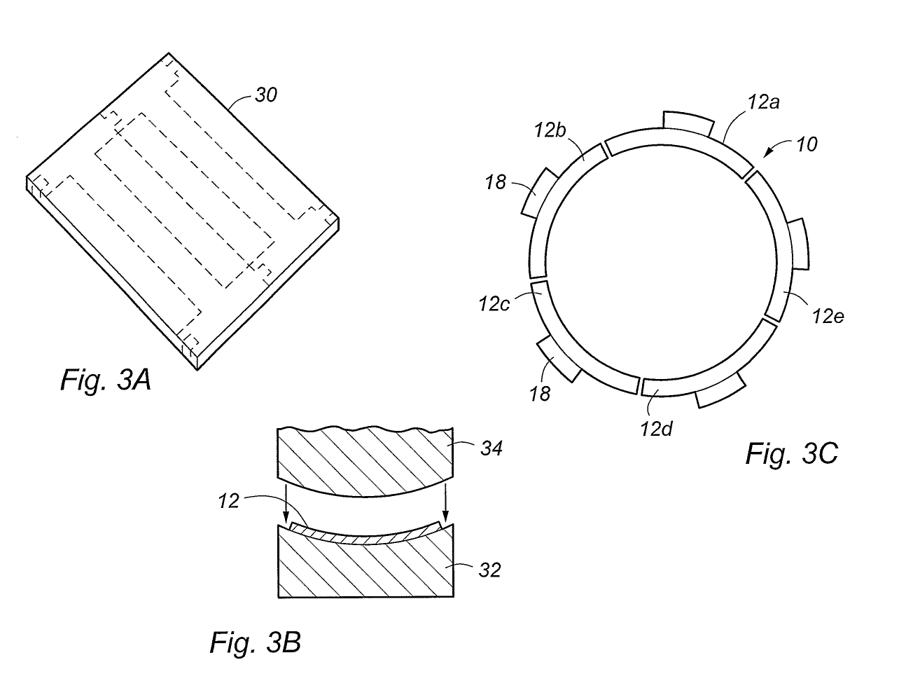

FIGS. 3A to 3C show schematically various stages of forming a centraliser in accordance with an embodiment of the invention;

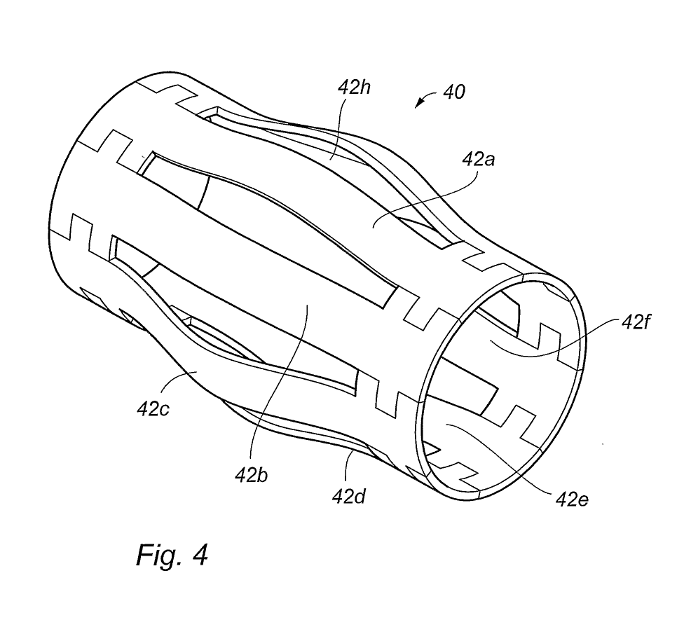

FIG. 4 is a perspective view of a centraliser in accordance with an alternative embodiment of the invention; and

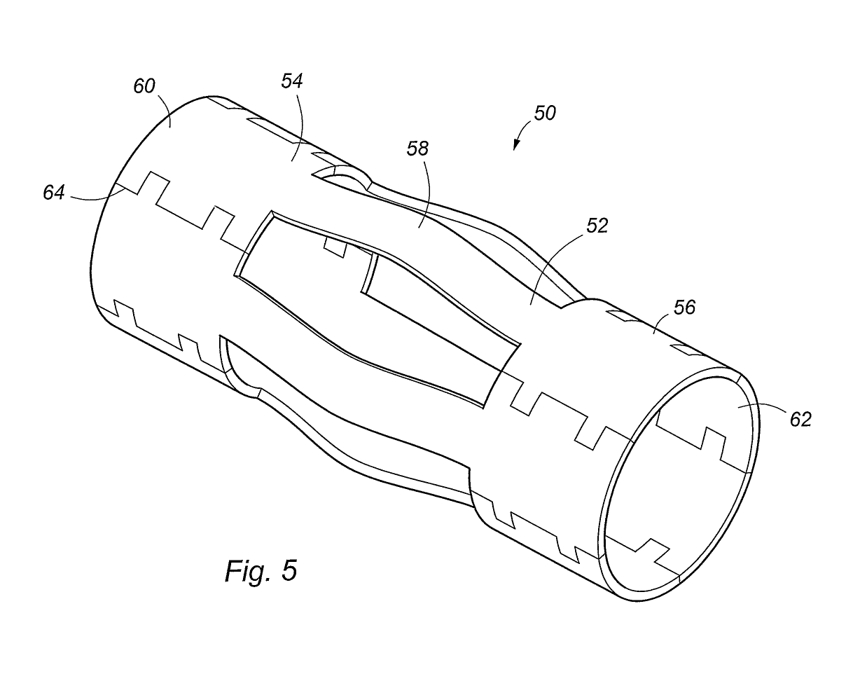

FIG. 5 is perspective view of a centralising tool in accordance with a further alternative embodiment of the invention.

Referring firstly to FIGS. 1 and 2A to 2C, there is shown at 10 a centralising tool formed from centralising members 12a to 12e (generally referred to as 12). Each centralising member 12 comprises first and second circumferential parts 14 and 16, separated by a longitudinal part 18. The centralising members 12 are of unitary construction, and extend continuously, without joins or seams, from one circumferential part 16 through the longitudinal part 18, to the second circumferential part 16. The centralising members are formed from a sheet of metal material, which in this case is a 4 millimetre thick sheet of steel alloy.

The centralising members are assembled together to form the centraliser. The circumferential parts are arranged to form a first ring 20, and a second ring 22 at an opposing end of the centraliser. The longitudinal portions have a formation which is upstanding from the outer radius defined by the collars to provide standoff to the centraliser and a tubular on which it is disposed. In this case, the centraliser is a bow spring centraliser, and the longitudinal portions 18 form arches or bow springs which reach a maximum outer diameter at around the centre of the longitudinal part 18. The centralising members 12 are joined to one another at seams or joins 24 between longitudinal edges which extend along of the centraliser. The respective longitudinal edges are provided with corresponding interlocking profiles, which increase the surface area of contact between adjacent members and also prevent relative axial movement. In this embodiment, the interlocking profiles comprise corresponding teeth 26 and recesses 28.

FIG. 3A shows a single sheet 30 of 4 millimetre thick steel alloy from which a pair of centralising members 12 are cut. In FIG. 3A, the dashed lines show the outline of the centralising members 12. As shown in FIG. 3B, the substantially flat centralising member 12 may then be pressed formed to create a curve, using a female mould 32 and a corresponding press 34. The recess has a curve with radius corresponding to the required radius of the centraliser. A subsequent press forming step (not shown) forms the bow in the longitudinal member 18. The centralising members 12 (which are now in the form shown in FIG. 2A) are arranged together to form the centraliser prior to welding, as shown in FIG. 3C. In this embodiment, the cylindrical members are assembled around a mandrel (not shown) to fully form the shape of the centraliser before welding begins. The circumferential parts are then welded together to form first and second collars of the centraliser.

In an alternative embodiment (not illustrated), adjacent centralising members can be arranged together and welded. Thus the assembly method may comprise sequential alternate steps of arranging a centralising member in contact with another centralising member, and welding the two together.

Although different welding processes can be used within different aspects of the invention, a preferred embodiment includes a static fusion welding method, which may involve electromagnetically vibrating and applying pressure to one or more of the centralising members 12.

FIG. 4 shows a centraliser 40 in accordance with an alternative embodiment of the invention. The centraliser 40 is similar to and will be understood from centraliser 10, and is formed from the same manufacturing process. However, in this embodiment the centraliser is formed from eight centralising members 42a to 42h. It will be understood that the invention is not limited to any particular number of centralising members, and may be as few as two and any odd or even number greater than two. In practical terms, the upper limit of the number of centralising members will be limited by the circumference, width and required mechanical properties of the centralising member.

FIG. 5 shows a centraliser 50 in accordance with a further alternative embodiment. The centraliser 50 is similar to and will be understood from the centraliser 10. Like components of the centraliser 50 are indicated by like reference numerals, incremented by 40. However, in this embodiment, the circumferential portions 54 and 56 are longitudinally extended. This results in first and second collars 60, 62 which are of increased axial length. This increases the surface area of contact between the centralising members, along which the weld is formed. In addition, the extended first and second collars provide a convenient surface for locating another functional element of the centraliser, for example a seal, which may be a metallic, elastomeric (natural or synthetic), or plastic seal layer, or a turbulator or other formation designed to induce turbulence in fluid flowing past the centraliser. It will be appreciated that the longitudinal dimension of the circumferential portions could be greatly increased in length. In addition, circumferential portions at opposing ends of the centralising member may be of different lengths, and may for example have one circumferential portion which is extended relative to the other.

The present invention provides a centraliser, and a method of forming a centraliser which overcomes the drawbacks of prior art centralisers and forming methods. For example, the centralising members which are used to assemble the centraliser are more easily transported to distant locations than bulky centralisers. The centralising members can then be welded together to at the remote location. This reduces transport costs and the amount of space taken up in a storage facility.

The present invention provides a method of assembling a wellbore centraliser comprising providing a plurality of centralising members. Each centralising member is of unitary construction and comprises first and second circumferential parts separated by a longitudinal part. First and second collars of the centraliser formed by welding first circumferential parts and second circumferential parts into rings. The invention also relates to a method of forming a centraliser by fusion welding and plurality of centralising members together.

Variations and modifications may be made to the above described embodiments within the scope of the invention, and the invention extends to combinations of features other than those expressly claimed.

For example, the centraliser may comprise one or more intermediate circumferential members disposed between first and/or second circumferential parts of at least one pair of centralising members. The intermediate circumferential members may be spacers, and may be provided without longitudinal parts.

1. A method of assembling a wellbore centraliser, the method comprising:
providing a plurality of centralising members, each centralising member being of unitary construction and comprising a first circumferential part, a second circumferential part, and a longitudinal part disposed between the first and second circumferential parts; forming a first collar by welding the first circumferential parts into a ring; and forming a second collar by welding the second circumferential parts into a ring.

2. The method as claimed in claim 1 , wherein the step of forming the first collar comprises forming a first collar comprised entirely of the first circumferential parts; and the step of forming the second collar comprises forming a second collar comprised entirely of the second circumferential parts.

3. The method as claimed in claim 1, wherein the step of forming the first and second collars comprises directly welding the respective first and second circumferential parts together.

4. The method as claimed in claim 1, comprising locating the first circumferential part of one centraliser member in abutment with the first circumferential part of another centraliser member, which members are to be welded together.

5. The method as claimed in claim 4, comprising locating the second circumferential part of said one centraliser member in abutment with the second circumferential part of said another centraliser member, which members are to be welded together.

6. The method as claimed in claim 1, comprising providing more than two centraliser members, the method further comprising locating a first end of the first circumferential part of a first member in abutment with a first end of the first circumferential part of a second member; and locating a second end of the first circumferential part of the first member in abutment with an end of a first circumferential part of a further member.

7. The method as claimed in claim 6, comprising locating a first end of the second circumferential part of the first member in abutment with a first end of the second circumferential part of the second member; and locating a second end of the second circumferential part of the first member in abutment with an end of the second circumferential part of the further member.

8. The method as claimed in claim 1, further comprising welding the first and/or second circumferential parts by a welding process selected from: fusion welding, MIG welding, TIG welding, and ARC welding.

9. The method as claimed in claim 8 further comprising welding the first and/or second circumferential parts by a static fusion welding process.

10. The method as claimed in claim 1 further comprising cutting or punching a centralising member from a sheet of material.

11. The method as claimed in claim 10 wherein the material is a steel alloy.

12. The method as claimed in claim 11 wherein the material is a carbon steel or a boron steel.

13. The method as claimed in claim 1 further comprising press-forming the centralising member to bend the first and second circumferential parts.

14. The method as claimed in claim 13 further comprising pressing the centralising member against a female mould, the female mould having a curved surface.

15. The method as claimed in claim 13 further comprising press-forming the longitudinal part to create a stand-off portion or a spring portion.

16. The method as claimed in claim 1 further comprising fitting the plurality of centralising members together to define a ring prior to a welding step.

17. The method as claimed in claim 1 further comprising the sequential steps of: fitting together two of the centralising members to form a partial ring; welding circumferential parts of the centralising members into a partial ring; and fitting a further centralising member to the partial ring.

18. The method as claimed in claim 1 comprising assembling the first and/or second circumferential parts in a complete ring defining the first and/or second collars.

19. The method as claimed in claim 1 comprising welding the circumferential parts of the centralising members to one another to form at least one of the first and second collars.

20. The method as claimed in claim 1 comprising disposing one or more intermediate circumferential members between circumferential parts of a pair of centralising members.

21. The method as claimed in claim 1 comprising welding the circumferential parts into the ring at opposing longitudinally edges, such that the welds extend longitudinally of the centralising members.

22. The method as claimed in claim 1 further comprising heat-treating the centraliser.

23. A wellbore centraliser comprising: a plurality of centralising members, each centralising member being of unitary construction and comprising a first circumferential part; a second circumferential part; and a longitudinal part disposed between the first and second circumferential parts; wherein the centraliser comprises a first collar formed from a welded ring of the first circumferential parts of the plurality of centralising members, a second collar formed from a welded ring of the second circumferential parts of the plurality of centralising members, and wherein the longitudinal parts of the centralising members extend between the first and second collars longitudinally of the centraliser.

24. The wellbore centraliser as claimed in claim 23, wherein the first and second circumferential parts of the centraliser members are shaped so as to form the first and second welded collars.

25. The wellbore centraliser as claimed in claim 23, wherein the first and second circumferential parts are shaped such that each forms a part of the respective first and second collars so that, when welded together, the circumferential parts describe the entire collars.

26. The wellbore centraliser as claimed in claim 23, wherein the first circumferential part of one centraliser member abuts the first circumferential part of at least one further centraliser member; and wherein the second circumferential part of said one centraliser member abuts the second circumferential part of said at least one further centraliser member.

27. The wellbore centraliser as claimed in claim 26, wherein said members together form the first and second welded collars.

28. The wellbore centraliser as claimed in claim 26, comprising at least one further centraliser member, and wherein: the first circumferential parts of the first, second and at last one further centraliser members together form the first collar; and the second circumferential parts of the first, second and at least one further centraliser together form the second collar.

29. The wellbore centraliser as claimed in claim 23, wherein at least one longitudinal part defines a spring portion.

30. The wellbore centraliser as claimed in any claim 23, wherein the first and/or second circumferential parts are assembled in a complete ring defining the first and/or second collars.

31. The wellbore centraliser as claimed in claim 23, wherein the circumferential parts of the centralising members are welded to one another to form at least one of the first and second collars.

32. The wellbore centraliser as claimed in claim 23, comprising one or more intermediate circumferential members disposed between circumferential parts of a pair of centralising members.

33. The wellbore centraliser as claimed in claim 23, wherein the circumferential parts are welded into the ring at opposing longitudinally edges, such that the welds extend longitudinally of the centralising members.

34. The wellbore centraliser as claimed in claim 33 wherein the longitudinal edges comprise corresponding interlocking profiles.

35. The wellbore centraliser as claimed in claim 34 wherein the corresponding interlocking profiles comprise at least one circumferentially extending tooth, and at least one circumferentially extending recess.

36. The wellbore centraliser as claimed in claim 23 comprising three or more centralising members.

37. The wellbore centraliser as claimed in claim 36 comprising four to eight centralising members.

38. A kit of parts, which when assembled together, form a wellbore centraliser, the kit of parts comprising: a plurality of centralising members, each centralising member being of unitary construction and comprising a first circumferential part, a second circumferential part, and a longitudinal part disposed between the first and second circumferential parts; wherein the first circumferential parts are configured to be welded into a ring to form a first collar of the centraliser, and the second circumferential parts are configured to be welded into a ring to form a second collar of the centraliser.
